(19) United States
(12) Patent Application Publication
(10) Pub. No.: US 2016/0142893 A1
(43) Pub. Date: May 19, 2016

(54) Disaster Mesh

(71) Applicant: Karla Dana, Clearwater, FL (US)

(72) Inventor: Karla Dana, Clearwater, FL (US)

(21) Appl. No.: 14/833,030

(22) Filed: Aug. 21, 2015

Related U.S. Application Data
(60) Provisional application No. 62/040,363, filed on Aug. 21, 2014.

(51) Int. Cl. H04W 4/22; H04B 7/185; G01S 19/01

(52) U.S. Cl. CPC H04W 4/22; G01S 19/01; H04B 7/18578; H04W 88/08

(57) ABSTRACT

Disaster Mesh is a small entity headed equally by Katelyn Dunn, Margaux Giles, and Karla Dana, that created the Disaster Mesh WiFi mesh network. The mesh network is connected by WiFi routers with solar panel chargers referred to as “seeds”. Each seed, is distributed by air drop within 30 meters. The seeds utilize the mesh network capabilities, and route devices to the Internet through the few seeds that also have a modem. The modem has a direct connect to the Internet, and supplies Internet to the rest of the seeds. Once connected, the user presses buttons to respond to questions regarding to their situation. The user's answer and GPS coordinates are collected and analyzed by Disaster Mesh. Disaster Mesh compiles the data into a map that contains information on the specific needs of the affected area.

### CROSS REFERENCE TO RELATED APPLICATIONS

This application claims priority to U.S. Provisional Patent Application number 62/040,353, filed on Aug. 21, 2014, which is incorporated herein in its entirety for all purposes.

### FIELD

Telecommunications Networks

### BACKGROUND

Common communications networks used in disaster relief include hand-held radios, cellular networks and mesh networks.

### SUMMARY OF THE DISCLOSURE

In disaster relief scenarios, a common problem that arises is that communication networks are not readily available on short notice for both the disaster survivors and first responders. In the scenario of the handheld radio/car radio, only disaster responders are able to transmit data to survivors, but survivors don't have the opportunity to transmit data to the survivors; in the scenario of cellular network, the network only covers some types of disasters, due to the fact that in several disasters cellular networks are destroyed—therefore this is not a reliable network. In the scenario of mesh networks, there is no efficient way to distribute the mesh nodes throughout a disaster struck area, as roads are commonly blocked and infrastructure disrupted.

The lack of an effective and efficient way of creating a real time communications network in disasters creates a situation whereby disaster responders have no way of rapidly contacting survivors, and vice versa; which consequently creates a situation whereby disaster responders have a reduced effectiveness in locating survivors and prioritizing resources as they lack information of exactly what is needed by what survivors. Furthermore, the lack of reliable infrastructure after a disaster prevents survivors from having an effective way of contacting their families or other survivors.

It is an object of this invention to solve these problems by utilizing an air-deployable mesh network using air-droppable devices with fixed wings, which function as individual mesh nodes and upon landing instantly establish a mesh network across the entirety of the zone into which they are air-dropped.

This invention does not rely on existing infrastructures, being solar-powered, containing a USB port and onboard battery for survivors or disaster responders to charge their devices, and relying only 3rd party services to extend their functionality.

### BRIEF DESCRIPTION OF THE DRAWINGS

FIG. 1 is an embodiment of the internal parts of one device FIG. 2. is a diagram showing the weight distribution of the device.

### DETAILED DESCRIPTION

Disaster Mesh is a wireless local area mesh network (WiFi) which is air-deployed in disaster-affected areas to create Internet connectivity among disaster survivors and disaster responders. Additionally, Disaster Mesh, not only provides an Internet connection to disaster survivors, but provides a platform to collect useful data on disaster-affected individuals. The information reported into the platform by disaster survivors is analyzed and used to maximize relief efforts.

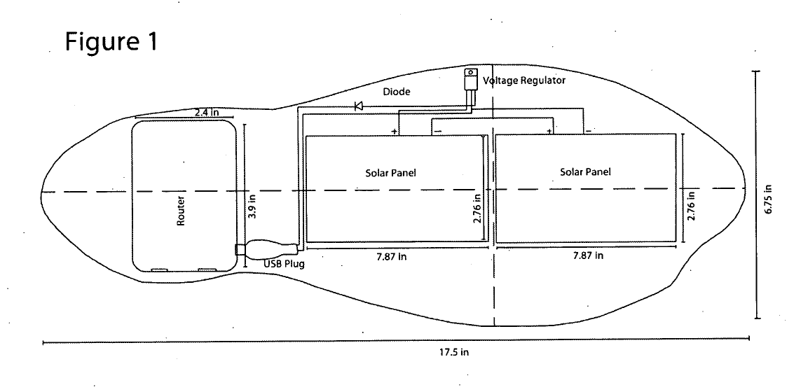

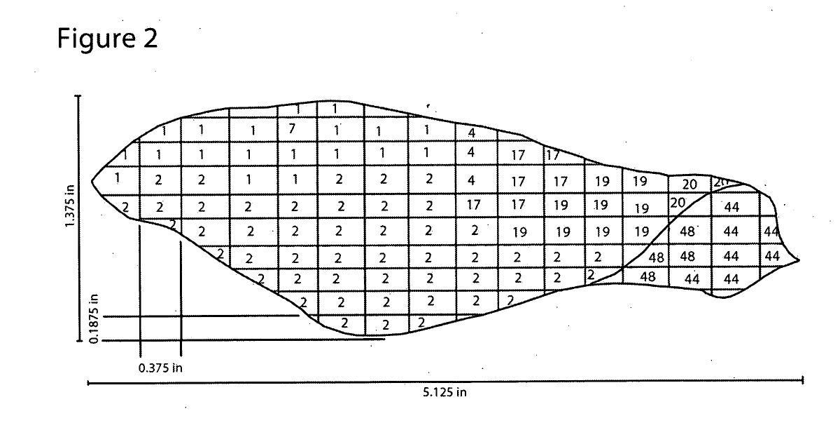

Disaster Mesh is a small entity headed by Margaux Giles, Katelyn Dunn, and Karla Dana. These individuals are the creators of the Disaster Mesh WiFi mesh network. The network operates in the following manner; Disaster Mesh creates a mesh WiFi network through the connection of mesh enabled WiFi access point. Each of the access points (constructed from routers, solar panels, onboard batteries, antennas and onboard memory) will officially be named “Seeds.” Seeds (See FIG. 1) will be equipped with solar panels to ensure that the WiFi network stays active when commodities such as electricity and telecommunications are unavailable in disaster areas.

Each WiFi seed is modeled through biomimicry to replicate the helicopter-like aerodynamics of a maple seed. When dropped, the seeds spiral to the ground, and land softly. The seeds are air-dropped by (but not limited to) airplanes, helicopters or drones, within (but not limited to) 30 meters apart. The seeds have a maximum distribution of 30 meters apart to ensure that the seeds are able to connect to the network, and within range. Each seed, with each other wireless to carry the requested information to the internet via a pre established communication channel established by the disaster responders. The Super Node which bridges the wireless mesh network to the Internet is provided by (but not limited to) a cellular service provider, fixed cable connection or a Satellite link. Each seed, within 30 meters, utilizes the mesh network capabilities, routing data requested to the SuperNodes that will supply Internet to the rest of the seeds.

Once connected to the network, users are directed to a predefined Emergency Response webpage. The full website will prompt users statements corresponding to their situation: “I need food,” “I need shelter,” “I need water,” “I need medical help,” “I am trapped,” and “I am okay, and then continue to the Internet.” The user presses the button that correlates to their situation. The answer and a GPS coordinate of the user is sent to a database which catalogs and prioritize the responses for disaster responders to manage. Information from multiple users is then analyzed to create an overall viewing map of the disaster struck area with accurate data of the supplies needed in the different areas. After answering the opening question, the user can continue to the Internet. The information is then utilized by relief organizations to allocate relief efforts more efficiently.

The Wifi Seeds provides wireless Internet access to those affected by disasters, allowing for connectivity, communication of disaster-affected individuals, and stimulation of relief efforts.

Summarize: Disaster Mesh is a small entity headed equally by Katelyn Dunn, Margaux Giles, and Karla Dana, who created the Disaster Mesh WiFi mesh network. The mesh network is connected by solar-powered WiFi access points which are referred to as “seeds”. Each seed is distributed by airdrop within 30 meters of another seed. The seeds utilize the mesh network capabilities and route devices to the Internet through one in several seeds that also contain modems. The modems have a direct connection to the Internet, and supply Internet to the rest of the seeds. Once connected to the network via smartphones or other devices with WiFi capabilities, the user press buttons to respond to questions regarding to their situation. The user's answer and GPS coordinates are collected and analyzed by Disaster Mesh. Disaster Mesh compiles the data into a map that contains information on the specific needs of the affected area.

1) A modular data communication device comprises a solar panel, a WiFi access point, a battery, a USB port and a supporting frame.

2) The modular data communication of device of claim 1 further comprises a GPS sensor.

3) The modular data communication device of claim 1 further comprises a light.

4) The modular data communication device of claim 1, wherein the device is in the shape of a silver maple seed.

5) The modular data communication device of claim 1, wherein the device is configured to be air-dropped.

6) A mesh network comprises a plurality of data communication devices configured to connect to satellite internet.

7) The mesh network of claim 6, wherein the mesh network works is configured to stand up to the elements.
